(19) United States
(12) Patent Application Publication
(10) Pub. No.: US 2004/0253473 A1
(43) Pub. Date: Dec. 16, 2004

(54) Metal foil composite structure for producing clad laminate

(76) Inventors: Michael Weekes, Ballston Lake, NY (US); Anthony J. Sirco, Melrose, NY (US); John Blaber, Clifton Park, NY (US)

Correspondence Address: Ernest D. Buff, Ernest D. Buff & Associates, LLC, 245 South Street, Morristown, NJ, 07960, US

(21) Appl. No.: 10/461,298

(22) Filed: Jun. 13, 2003

(51) Int. Cl. B32B 15/04; B32B 3/04

(52) U.S. Cl. 428/595; 428/615; 428/76

(57) ABSTRACT

A metal foil composite structure used for the construction of clad laminate and printed circuit wiring boards comprises first and second conductive metal foil layers having substantially the same width. Each of the layers has opposite lateral edges. A carrier layer is disposed between the first and second conductive metal layers. The carrier layer has a width less than the width of the first and second conductive metal layers, and forms a margin at each of the lateral edges. The first and second conductive layers are joined to each other only within the margins. Strength provided by the carrier enables thin conducting metal foils to be incorporated in clad laminates. Such foils, which may be as thin as 8-10 μm, are often too weak to be reliably self-supporting. The provision of a supporting carrier layer enables the thin foils to be handled and bonded to a dielectric substrate in an efficient and economical manner. Defects in the resulting clad laminate, such as wrinking or creasing of the thin foil, are virtually eliminated. The composite foil structure is readily formed in continuous, indeterminate lengths.

### BACKGROUND OF THE INVENTION

1. Field of the Invention

The present invention relates to a conductive metal foil sandwich for producing clad laminate; and more particularly, to a composite structure having a carrier layer interposed between conductive foil layers, the structure being useful in the production of clad laminate and printed circuit wiring boards.

2. Description of the Prior Art

Circuit boards used in modern electronic devices generally comprise one or more distinct layers of electrically conductive metal, frequently Cu, that are selectively etched to define traces. These traces are used to interconnect components mounted on the board, thereby providing the device with a certain functionality. Components that populate the board typically include digital and analog integrated circuits of many types. They also include semiconductor devices, as well as resistors, capacitors, inductors, and related items. Metal layers are generally provided as thin metal foils laminated to one or both surfaces of a dielectric, non-conductive structural substrate. The substrate may be rigid, such as a fiberglass-reinforced epoxy composite, or flexible, such as a thin polyimide sheet. Metal layers in a multi-layer board are further separated by insulating, dielectric layers. A need for miniaturization of components, as well as rapid advances in the sophistication and operating speeds of individual components and the circuits assembled therewith, have led to requirements for improved circuit boards, in order that the potential benefits of novel components and circuits can be realized in an industrially viable way.

One specific requirement is that improved circuit boards must accommodate an increased number of interconnection traces within a small space, so in turn, there is a corresponding need for each of the traces to be made narrower. In practice, forming a pattern of narrow traces in conductive layers of conventional thickness using known photolithographic etching methods presents a significant challenge because of the phenomenon of undercutting. It is desired that the etching process produce traces which have a rectangular cross-section, i.e. traces having substantially the same width at each level between the respective top and bottom surfaces of the conductive layer. However, conventional etching processes inherently produce some degree of undercutting. In particular, the etching removes material both vertically from the free surface of the foil, as desired, and horizontally from the sides of the traces as they are formed. In most cases, the sides of a trace become tapered inwardly in going from the free surface to the foil-substrate interface. The extent of this undercutting increases in rough proportion to the foil thickness. A degree of undercutting that might be tolerable for wide traces is not acceptable for narrower traces. Undercutting decreases the width of the trace near the foil-substrate interface, sometimes to an extent that compromises the bonding of the trace to the underlying circuit board. In some particularly severe cases, the undercutting may even sever the mechanical and electrical continuity of the trace. Either situation may render the circuit board inoperable or make it prone to premature, mechanically-induced electrical failure. These problems may be manifest even in a newly produced board or may be exacerbated by the heating experienced during extended operation and thermal cycling. The prospect of such failures clearly indicates the need for improved circuit boards and methods.

Accordingly, workers have recognized the need for the thickness and width of circuit board traces to be reduced concomitantly in order to provide a circuit board that satisfies the needs of circuit builders for both performance and durability. However, decreasing the thickness of the copper foil to the 8-10 μm now sought results in other severe problems. It will be recognized by those familiar with the circuit board and laminate arts that foil thicknesses may be expressed either directly as an actual thickness, or indirectly, as the areal mass density of the foil. For example, a commonly used circuit foil is said to be “one ounce copper foil,” meaning that a square foot of such foil weighs approximately one ounce. Using the known volumetric mass density of pure copper, it may be determined that a one-ounce foil is approximately 35 μm thick.

Unfortunately, conventional processing techniques have proven difficult or impossible to use in making laminates and circuit boards employing either wrought or electrodeposited foils as thin as the desired 8-10 μm. Such foils are generally found not to be self-supporting, so they cannot readily be produced, handled, and bonded to substrates in the required manner without tearing, wrinkling, creasing, or becoming deformed in similar ways. A circuit device assembled using a laminate with such defects is likely to be inoperable as produced or to fail prematurely.

Therefore, workers have proposed methods for supporting conductive layers that are otherwise too thin to be handled and affixed to copper laminate and circuit board. Some of these methods employ auxiliary supporting layers. Ideally a carrier layer would have sufficient strength to support the thin foil during its application onto the laminate substrate, yet be removable thereafter without damaging, wrinking, or otherwise inducing defects in the conductive layer. In addition, an ideal supporting layer would leave no residue and be inexpensive enough to be disposable or recyclable at minimal cost. However, the solutions proposed heretofore have not adequately exhibited these desirable features.

U.S. Pat. No. 5,153,050 to Johnston discloses a laminate of copper foil and a supporting sheet used in manufacturing articles such as printed circuit boards. The supporting sheet is said to be aluminum or the like. The sheets are joined around their borders by a band of flexible adhesive. In addition, the patentee suggests formation of islands of adhesive inwardly of the edges of the sheets through which tooling pinholes may be formed to facilitate handling.

World Patent Publication WO 97/25841 discloses a component used in the manufacture of circuit boards, comprising sheets of copper foil positioned on the surfaces of a substrate, e.g. an aluminum sheet. The edges of the copper foils extend to a margin overlapping two opposite edges of the substrate. The copper sheets are attached to the substrate by a flexible adhesive such as a rubber cement. The locality on which the adhesive is deposited may be either with or without interruption around the periphery of the copper sheet, as long as it joins the copper to the aluminum sufficiently to maintain the essentially uncontaminated character of the central zone of the copper. The publication further discloses a method for forming copper clad substrates using such an aluminum/copper layered structure.

German Patent Publication No. DE 198 31 461 C1 discloses a method relating to the joining of copper foils of any type and thickness to aluminum sheet metal of any type of alloy and of any thickness to simplify the assembly of multilayered press packs. Two copper foils of any type and thickness and an aluminum sheet of any type of alloy and of any thickness are said to be joined to one another so that this joint lies outside the useful area.

U.S. Pat. No. 5,942,314 discloses a laminated structure used in making printed circuit boards. The structure has a metal carrier strip ultrasonically welded to a copper foil at their edges. The supporting strip is preferably aluminum or stainless steel.

U.S. Pat. No. 6,127,051 provides a sheet laminate having a metal substrate layer, such as steel, and a copper foil layer disposed on at least one surface of the substrate layer for use in manufacturing printed circuit board. A series of resistance welds around the quadrilateral periphery of the substrate layer join the copper foil thereto. Steel is said to be preferable to aluminum for use as the substrate, since its coefficient of thermal expansion more closely matches that of the copper foil. U.S. Pat. No. 6,129,998 also discloses a sheet laminate having a steel substrate and a copper foil layer disposed on at least one surface of the substrate layer, the copper and steel being adhered by plural occurrences of adhesive material disposed along the boundary of the foil layer.

Many approaches for production of clad laminate, including those employed by the aforementioned patentees, require that the conductive foil be rigidly affixed to the edges of the carrier layer, such as by gluing or welding. In many cases, the mismatch of coefficients of linear thermal expansion (CTE) between rigidly attached carrier sheet and conductor foils is likely to cause warpage or wrinking of the conductive foil during the hot pressing (typically to about 150-200° C. or more) used in most laminate production. Such a problem is exacerbated by the use of aluminum as a carrier, since it has a CTE nearly 50% higher than copper. In addition, methods that use glue, solder, or other ancillary joining materials adversely impact the recyclability of either the carrier or the conductive material. In addition, glue has a marked tendency to produce deleterious dust and other residue that frequently induce unacceptable defects in the ultimate circuit board. Furthermore, many of these approaches entail that the attachment of the conductive foil be accomplished on all four sides of a rectangular carrier layer, thus precluding forms of supply in which indeterminate lengths of the composite structure product are desired. Such indeterminate lengths ideally would be produced and supplied in roll form, thereby simplifying supply logistics and facilitating automated, continuous production methods.

In other methods, the conductive foil is adhered over substantially its entire area to a carrier layer, e.g. by chemical or metallurgical bonding, gluing, electroplating, or other like process. For example, the thin conductive layer may be adhered to an aluminum carrier, which subsequently can be removed using a strongly alkaline or basic solution which preferentially etches aluminum without attacking copper. Such a process undesirably increases the cost of production, since the aluminum metal is consumed and so cannot be reused or recycled expeditiously. In addition, disposal of the spent etchant in an environmentally acceptable way is difficult and expensive, further complicating the process.

Notwithstanding the advances represented by these disclosures, there remains a need in the art for a carrier system that provides adequate support for conductive foil that is otherwise too thin to handle, yet produces a satisfactory laminate product with few or no defects, extraneous foreign matter, and the like. Such laminate is needed, in turn, both for simple circuit boards using only top and bottom layer traces, and more importantly, as an element used in constructing multi-layer circuit boards that are essential for present and future electronic equipment and computers.

### SUMMARY OF THE INVENTION

The present invention provides a metal foil composite structure useful for supplying a thin, conductive foil that may be laminated to one or both sides of a dielectric substrate to form a copper-clad laminate. The laminate, in turn is useful in the fabrication of clad laminates and printed circuit wiring boards.

More specifically, the metal foil composite structure comprises: (i) first and second conductive metal foil layers having substantially the same width, each layer having two opposite lateral edges; and (ii) a carrier layer having a width less than the width of the first and second conductive metal layers and being disposed therebetween, forming a margin at each of the lateral edges. The first and second conductive layers are joined to each other within the margins.

Preferably, the thin conductive layers are composed of a copper foil of one of the types commonly used in the production of circuit boards and clad laminates, including foils ranging from nominal ¼-ounce (9 μm) to 2-ounce (70 μm) thickness. The carrier layer is preferably an aluminum alloy sheet having a thickness ranging from about 100 to 1000 μm, and more preferably from about 180 to 500 μm.

Advantageously, the use of the present metal foil composite structure makes it possible to reliably handle thin conductive foil that in many instances is too thin to be self-supporting. As a result, the foil can be incorporated in clad laminate and circuit boards without producing wrinking, folding, and other mechanical defects that are commonly found when using other forms of supply of the foil.

The invention further provides a method of producing a metal foil composite structure. The method employs first and second conductive metal layers having substantially the same width, each conductive metal layer having two opposite lateral edges and a carrier layer having a width less than the width of the first and second conductive metal layers. The carrier layer is interposed between the first and second conductive metal layers to form a margin at each of the lateral edges and the conductive layers are joined to each other only within the margins.

Preferably, the metal foil composite structure is produced in a continuous process, in which the conductive metal layers and the carrier layer are dispensed from supply spools. In some embodiments, foil emerging from the joining operation is transversely cut, e.g. by shearing, into preselected lengths used for subsequent processes. Alternatively, the composite structure is produced in extended lengths that are optionally collected on a takeup spool. The collected material may then be stored for later processing, e.g. to form clad laminate. Advantageously, the layers of present metal foil composite structure are joined only in the margins at the two lateral foil edges, and not at the leading and trailing edges.

Still further, a process for forming a clad laminate is provided in accordance with the invention. The laminate is formed by bonding one of the conductive metal layers of the aforementioned metal foil composite structure to one of the surfaces of a dielectric substrate having a top surface and a bottom surface. Preferably, the process forms a plurality of clad laminates. A plurality of the dielectric substrates are stacked with one of the metal foil composite structures interposed between adjacent substrates and conductive foil end layers are placed on the outermost surfaces of the first and last substrates, thereby forming a book. The book is pressed between the platens of a press and heated. The book is then cooled to effect a bond linking each of the conductive layers in the metal foil composite structures and the conductive foil end layers to the surface of the dielectric substrate proximate that foil to form a clad laminate from each of the dielectric substrates. Subsequently the book is separated by parting the peripheral joined edges of the foils of the composite structures, thereby releasing the individual clad laminates and the carrier layers of each composite structure. Preferably, the dielectric substrate is an epoxy-laden, fiberglass reinforced prepreg, although other substrates, such as polyimide films, cyanate esters, polyesters, PTFE, and BT may also be used, in either flexible or rigid forms.

The use of the present metal foil composite structure in the formation of clad laminates virtually eliminates many of the difficulties associated with other methods of forming the laminates. The thin conductive foils of the composite are provided with strength by the enclosed carrier layer, allowing the cladding to be accomplished without wrinking, folding, tearing, or otherwise deforming the foil. As a result, the clad laminate is reliably produced without such defects, which are highly likely to compromise the integrity and durability of circuit traces that are ultimately formed by etching the foil for its end use. Moreover, the conductive foils are not bonded to the carrier. In previously known processes, differential thermal expansion of the foils and the carrier, especially during the formation of the laminate by hot pressing and subsequent cooling, frequently result in warpage of the laminate. Warped laminates are totally unacceptable for use in the production of circuit board for a variety of reasons, in particular, difficulties encountered in the application of photoresist. By way of contrast, the carrier in the present composite structure is not attached or affixed to the conductive foils, allowing differential thermal expansion to be accommodated without warping or deforming the foils.

### BRIEF DESCRIPTION OF THE DRAWINGS

The invention will be more fully understood and further advantages will become apparent when reference is had to the following detailed description of the preferred embodiment of the invention and the accompanying drawings, in which:

FIG. 1 is a plan view depicting a metal foil composite structure of the invention;

FIG. 2 is a lateral cross section view of the metal foil composite structure of the invention shown in FIG. 1, taken at level II-II;

FIG. 3 is a lateral cross section view depicting a metal foil composite structure of the invention, wherein the outer copper foils are joined by an alternative crimping method;

FIG. 4 is a schematic elevation view depicting a continuous process for producing the metal foil composite structure of the invention; and

FIG. 5 is a side view depicting a method by which copper clad laminate of the invention is produced in a press under elevated temperature and pressure.

### DESCRIPTION OF THE PREFERRED EMBODIMENTS

The present invention provides a metal foil composite structure including thin conductive metal layers, which, in turn, can be laminated to a dielectric substrate to form a clad laminate. The conductive layer is as thin as 5 μm, so that the laminate can be etched to form a high density of narrow, but well-defined conductive traces. Although an individual laminate may be used as a single or double-sided circuit board for some simple electronic devices, in most cases a plurality of laminates are stacked and bonded together to form a multi-layer circuit board. The board is subsequently populated with various electronic components that are interconnected using the traces formed on the various laminate layers.

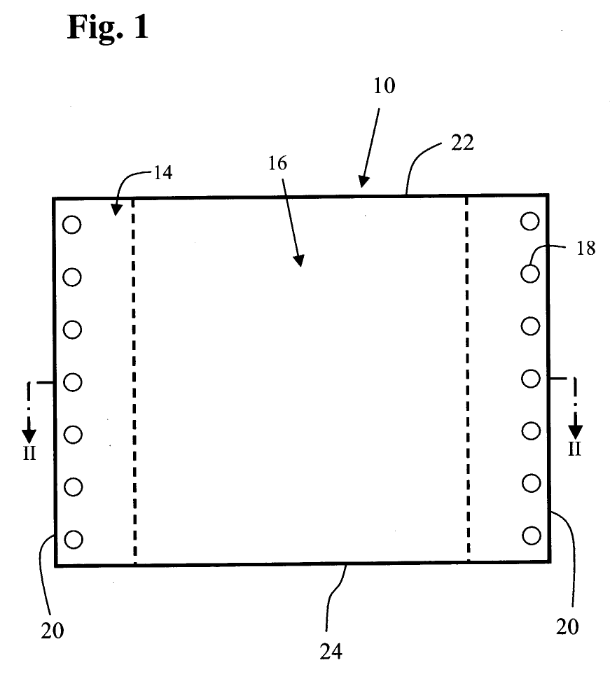

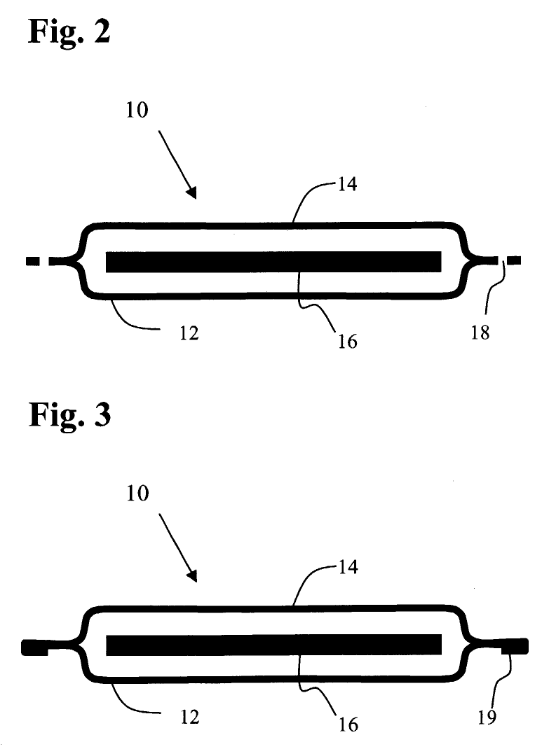

An embodiment of the invention is depicted by FIGS. 1-2, which show generally at 10 a metal foil composite structure useful in the manufacture of clad laminate. Carrier layer 16 is preferably a metal sheet or strip, and more preferably, at least one sheet selected from the group consisting of copper, aluminum, nickel, steel, and stainless steel sheets. The carrier sheet is optionally coated or plated with metallic or polymeric materials that impart at least one of corrosion resistance, abrasion resistance, and surface hardening or hardfacing to the carrier. Alternatively, a sheet-form polymeric material having sufficient thermal stability for the subsequent steps used in forming clad laminates or circuit boards may be used as carrier 16. The polymeric material may incorporate fillers, reinforcing fibers, or other functional additives. The carrier layer is surrounded by first and second conductive thin foils 12, 14, which have similar widths that provide a slight overhang on each side of the carrier 16. Preferably the margin on each side ranges from about 3 to 25 mm. More preferably, the margin ranges from about 10 to 15 mm. In the embodiment shown, a pin punch has been used to create holes 18 penetrating conductive foils 12, 14. The ensuing deformation creates a weak bond joining the foils 12, 14 to each other, the joint being confined only to their lateral edges only. Foils 12, 14 surround carrier 16 but are not otherwise attached to it. Advantageously, the joining is carried out without other alignment holes within the area of the carrier layer, thereby maximizing the use of both the carrier layer and the conductive foils.

More specifically, the holes 18 are located in the lateral margins of the sandwich structure, i.e. the regions in which the conductive layers 12, 14 overhang carrier 16. Preferably, the holes 18 are disposed at regular intervals along lines inward of, and generally parallel to, the lateral edges 20 of foil layers 12, 14, but outward of the lateral edges of carrier 16. Advantageously, the action of the pin punch creates a deformed lip at the periphery of the holes in each foil. The lips provide mutual engagement that is sufficient to fixedly join the conductive foil layers to each other without use of another material or substance. However, only a modest force is required to part the foils, permitting them to be readily separated after they are bonded to dielectric substrates during the production of clad laminate, e.g. by the below-described process. The individual edges of the three layers of structure 10 are substantially coincident at the leading 22 and trailing 24 edges of structure 10. Advantageously, the joints at lateral edges 20 are sufficient to secure the layers of structure 10 without joints or overhanging margins at the leading and trailing edges 22, 24. As a result, a structure of preselected length may be cut from a longer supply length at edges 22 and 24 using either manual or automated cutting methods. Moreover, the resulting ability to form structures 10 of any desired size affords great flexibility to a fabricator who can stock extended lengths of joined foil, yet expeditiously prepare any desired shorter length by a straightforward cutting method.

The conductive foil layers 12, 14 of the metal foil composite structure 10 may be composed of any conductive metal having the requisite combination of chemical, mechanical, and electrical properties for a clad laminate application. The foils may be wrought, electrodeposited, or otherwise produced. Preferably, the conductive layers are composed of copper foils of the type conventionally used in circuit boards and clad laminates and range in thickness from about 5 to 400 μm. More preferably, the conductive layers are electrodeposited copper foil of the type commonly used in circuit board and clad laminate and have a thickness ranging from that of the nominal ¼-ounce to 2-ounce types, i.e. about 8 to 70 μm. Carrier 16 is preferably composed of aluminum having a thickness ranging from about 25 μm to about 1.5 mm. More preferably the aluminum ranges from about 0.2 to 0.6 mm thick. One suitable carrier is a commercially available 3000-series aluminum alloy sheet. The thickness and hardness preferred for the carrier layer will vary, depending on the materials chosen for both the carrier and conductive layers. For example, steel carrier sheets will generally be thinner to compensate for their higher density and strength. Thicker carriers are generally preferable for use in conjunction with thicker conductive foils, so that the carrier provides the preponderance of strength of the overall structure.

The present metal foil composite structure may be made with foils of any width. Preferably, the conductive foils have a width ranging from about 30 to 150 cm. At greater widths, handling and process control requirements become more demanding, making it difficult to control defects in the conductive foils such as wrinking. Production requirements become even more exacting when handling conductive foils thinner than about 15 μm. Wider structures are also more difficult to handle in the layup operations typically used for laminate production.

Advantageously, the conductive foils of the present structure are bonded only to each other on two sides, and not constrained by attachment to the intermediate carrier layer. As a result, the propensity of previous layered structures to bend or warp during thermal cycling due to differential thermal expansion of the outer and inner layers is minimized or eliminated. Such warpage has been found to result in significant production problems and defects in the foil of clad laminate. Warpage arises principally during the hot pressing operations used to adhere the conductive foil to the dielectric substrate during laminate production, such as that discussed hereinafter in greater detail. The foil is found to be especially vulnerable during the cooling phase of the pressing cycle.

A variety of techniques may be used to join the conductive foil edges. In some embodiments, an adhesive agent is continuously or discontinuously applied to the edges of one or both the foils to effect the joining. The edges may also be soldered, welded, or brazed. Preferably, the joining does not require the use of third materials, either adhesive or filler metals for soldering, welding, or brazing. Resistance welding, spot-welding, and ultrasonic welding are preferred welding processes. More preferably, mechanical deformation processes are employed to join the foils. For example, the edges may be crimped as shown in FIG. 3, with the lateral edges of top layer 14 bent around the edges of bottom layer 12 forming crimps 19. Crimping, as used herein and in the appended claims, is understood to mean closing, uniting, or making continuous by collectively deforming, pinching together, or folding. In other embodiments, an oscillating pin punch or rotary punch is used to penetrate the foils, resulting in deformation and inter-engagement of material from both layers of conductive foil. Other deformation techniques may also be used and are within the scope of the present invention. Suitable joining techniques provide permit the foil composite structure with strength that is adequate for the subsequent handling and process steps used in producing clad laminate. Following lamination of the conductive foils to the laminate substrate, the foil edges are either disengaged or trimmed off to separate the two laminates to which the cladding foils of the composite structure have been attached. In certain preferred implementations of the invention, the mechanical joining of the conductive foils is found to be weakened during the thermal cycling typically used to form clad laminate. More specifically, the conductive foils of each composite structure are adequately held before the lamination process, but may be separated afterward with little or no force. As a result, the potential for damaging the clad laminate during separation of the booked stack (described in more detail hereinbelow) is virtually eliminated.

Preferably, conductive foil layers used in the present composite structure have a thickness as low as about 8 to 10 μm, and in some cases as little as about 5 μm. Foils this thin are generally found to be almost impossible to handle and incorporate in printed circuit wiring boards using conventional methods. Such foils do not have adequate strength to prevent tearing, wrinkling, kinking or other undesirable deformation during required processing steps. Advantageously, carrier layer 16 affords the present metal foil composite structure strength and handleability sufficient to allow production of clad laminate with the conductive layer. The dielectric substrate of the laminate provides needed support after the conductive foil is bonded thereto.

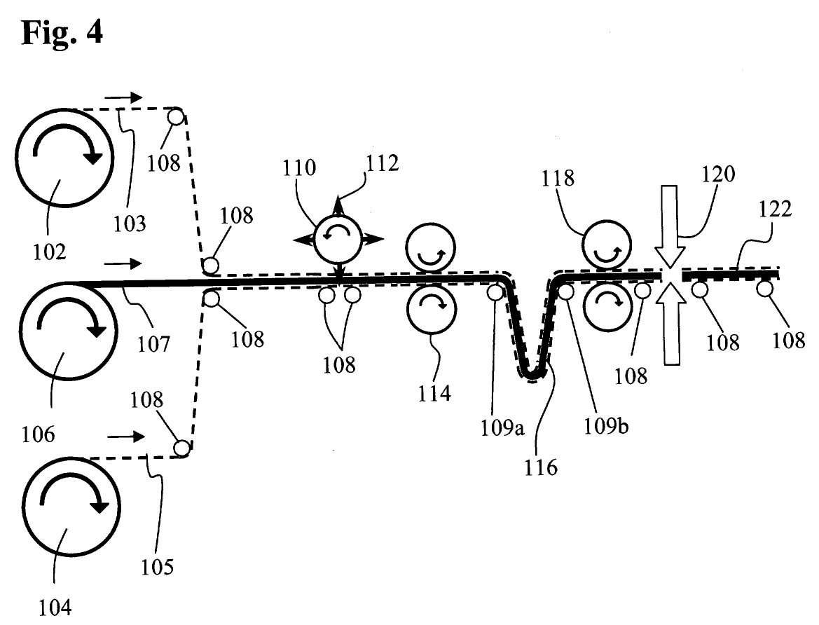

It is further preferred that the metal foil composite structure be produced in a continuous process. By way of contrast, previous processes wherein conductive foils must be adhered on four edges surrounding a carrier layer are not readily amenable to continuous processes. One preferred continuous process is depicted by FIG. 4. Supply spools 102 and 104 dispense first and second thin conductive foils 103, 105, while supply spool 106 provides carrier layer 107. The rotation of the spools and the feed directions are shown by arrows in FIG. 4. The paths and alignment of the foils 103, 105, 107 are established by guide rolls 108. The foils thread through the nip of counter-rotating drive rolls 114, which are urged to rotation in the indicated direction by a motor (not shown), which may be an electric or pneumatic device. In turn, the drive rolls advance the foils 103 and 105 and carrier sheet 107 collectively. A rotary punch assembly 110 is located near each edge of foils 103, 105. Each punch assembly 110 has a plurality of radially extending punches 112 and is rotatably engaged by the forward motion of the foils, causing the punches to periodically pierce the edges of foils 103 and 105 in the margins outward of carrier 107. After passing through punches 110 and drive rolls 114, the now-joined foils and carrier sheet pass over idler guide rolls 109a and 109b, and accumulate as idler loop 116 therebetween. The joined foils and carrier emerging from the idler loop 116 are engaged in the nip between counter-rotating, indexing drive rolls 118 which are urged to rotation in the indicated direction by a motor (not shown). Indexing drive rolls 118 advance the joined foils and carrier incrementally, stopping to allow shear 120 to transversely sever sections 122 of joined foils and carrier into preselected lengths of the composite structure. Sections 122 are collected and removed by an operator manually or by conventional automated handling and removal means (not shown). In an alternative embodiment (not shown), indeterminately long sections of joined foil emerging from drive rolls 114 are collected directly and wound onto a take-up spool, instead of being sheared as shown in FIG. 4.

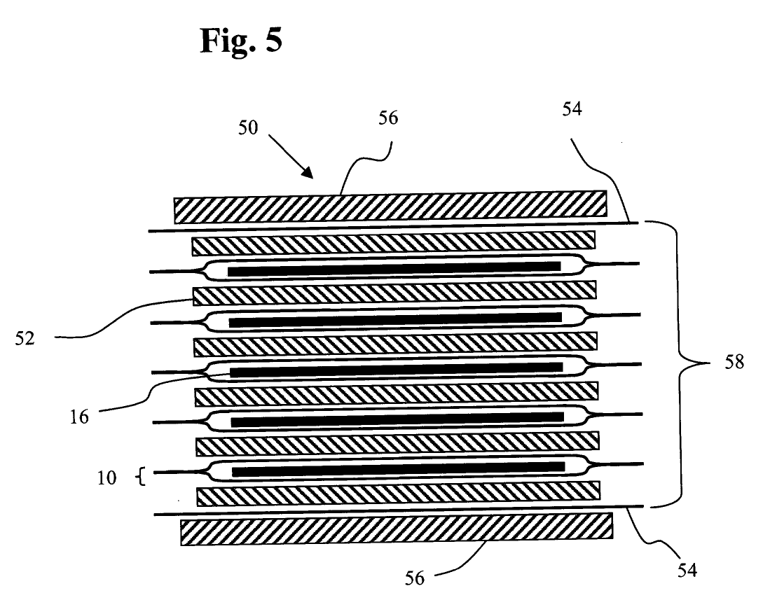

FIG. 5 depicts the production of a plurality of copper-clad laminates in accordance with an embodiment of a further aspect of the invention. As shown generally at 50, several large rectangular sheets of fiberglass-reinforced, epoxy-laden prepreg 52 are provided in the requisite thickness, which is preferably about 0.05-1 mm thick. The prepregs are stacked with present composite foil sandwich structures 10 interposed between adjacent prepregs. The outermost sides of the first and last prepregs of the stack are provided with conductive foil end layers. In the embodiment shown, each end layer is provided by a single layer of conductive foil 54, which is preferably the same material as the conductive outer layers of the other metal foil composite structures 10. Alternatively, each end layer may have a configuration 25 substantially the same as one of the metal foil composite structures 10. With this configuration, each end layer comprises a composite structure having a carrier layer surrounded by first and second conductive thin foils, which have similar widths that provide a slight overhang on each side of the carrier. The conductive thin foils are joined to each other in the margin outward of the carrier layer. The outermost layer of the composite structure that provides the end layer does not have an adjacent prepreg, and so it remains unbonded and is ultimately discarded or recycled. In another alternative, a special one-sided arrangement of the metal foil composite structure is employed for the end layers. In this one-sided arrangement, the composite is prepared using a sacrificial layer instead of one of the conductive foil layers. For example, the sacrificial layer can be a polymeric film release layer (such as a polyester or other known release film) or a thin, sacrificial metal layer such as aluminum. Such one-sided forms are to be understood as falling within the scope of the present invention. The assembled sandwiches 10, prepregs 52, and outer foil layers 54, collectively known as a book 58, are disposed between press plates 56. Together the book 58 and the press plates 56 are placed between the horizontal platens of a large, heated press (not shown). The entire assemblage is heated to a temperature for a time and at a pressure sufficient to cause the epoxy in each prepreg 52 to soften. The epoxy subsequently hardens to make the substrate rigid and effect a bond linking each of the conductive foils in sandwiches 10 and foils 54 to the face of the prepreg 52 proximate that foil. The pressure is then released and the book allowed to cool, thereby forming a double-sided, clad laminate from each prepreg. The particular conditions of time, temperature, and pressure used in the lamination process may be adjusted, depending on the nature of the dielectric substrate, the epoxy, the thicknesses of the conductive foils and carrier, and the number of layers of clad laminate being formed.

The now-cured prepreg functions both as the substrate providing mechanical strength and as a dielectric to insulate the conductive layers from each other. Subsequently, the book is separated by parting the peripheral joined edges of the foils in each of the metal foil composite structures, thereby releasing the individual clad laminates and the carrier layers of each composite structure. Preferably, the separation further comprises trimming the edges of each laminate. The carrier layers 16 and the edge-trimmed material are preferably reused or recycled. The foregoing method permits clad laminate to be reliably and efficiently produced.

A wide variety of dielectric substrates may be clad using the present process. Preferably, a fiberglass-reinforced, epoxy-laden prepreg is incorporated in the laminate. Other materials may also be used, such as polyimide films, cyanate esters, polyesters, PTFE, and BT. The laminate may be produced in either flexible or rigid forms.

Clad laminates may be formed in a wide variety of sizes using the present process. Often, laminates are produced as large, rectangular sheets that are ultimately cut to smaller sizes used in computers and other electronic equipment. Common sizes for the large sheets range from about 60×100 cm to as much as 140×300 cm. The large sheets are then typically cut into boards, for which sizes of 30×45 cm and 60×70 are exemplary. It will be understood that production considerations and diverse end uses may make other sizes advantageous as well.

In still another aspect of the invention there is provided an improved method for producing multi-layer circuit boards, the improvement comprising use of laminates produced by the aforementioned process. The laminates are etched in a conventional manner to define circuit traces, after which the formed laminates are stacked and joined to form a multilayer board.

The following examples are presented to provide a more complete understanding of the invention. The specific techniques, conditions, materials, proportions and reported data set forth to illustrate the principles and practice of the invention are exemplary and should not be construed as limiting the scope of the invention.

### EXAMPLES 1-3

### Laboratory-Scale Preparation of Copper Foil Composite Structures

A three-layer copper foil sandwich is prepared using the following laboratory scale process steps to form the various layers in a configuration generally similar to that shown in FIGS. 1-2:

(i) A first conductive metal foil layer composed of nominal ½ ounce copper circuit board foil, about 45 cm wide, 50 cm long, and 18 μm thick is placed on a table;

(ii) A generally rectangular, sheet of 3000-series aluminum alloy about 43 cm wide, 50 cm long, and 380 μm thick is provided as a carrier layer and is placed approximately centered on the first conductive metal foil;

(iii) A second conductive metal foil layer substantially identical to the first conductive metal foil layer is placed onto the carrier layer to form a rectangular sandwich configuration. On two opposite sides of the configuration there is a margin of about 1 cm wherein the conductive layers extend beyond the lateral edges of the carrier, while the leading and trailing edges of the aluminum and copper layers on the two opposite ends of the configuration are substantially aligned and coincident;

(iv) An industrial sewing machine is operated without thread and using a sewing needle ground to a blunt end to periodically puncture the copper foils, thereby providing a series of holes joining the foils along a line slightly inward of, and parallel to, the side edges of the foils in the margin area.

The foregoing steps result in the formation of a sandwich-like structure having exterior copper layers joined on two sides only, with an interior aluminum carrier layer substantially centered between the lateral edges of the copper layers. The aluminum layer is not affixed to the copper layers, thereby allowing the aluminum and copper to expand and contract differentially minimizing or eliminating the tendency for the layers to bow or warp during subsequent production of copper clad laminate or circuit board using a metal foil composite structure.

A second metal foil composite structure is constructed using substantially the same process, except that the copper foils used are nominal 1-ounce types, about 35 μm thick.

A third metal foil composite structure is constructed using substantially the same process, except that the copper layers are nominal ½-ounce copper foil about 18 μm thick, 70 cm wide, and 190 cm long, and the aluminum sheet is about 68 cm wide and 250 μm thick.

### EXAMPLE 2

### Preparation of a Copper Clad Laminate

A plurality of copper foil composite structures having outer layers of nominal ½-ounce copper circuit board foil and an intermediate layer of 380 μm thick, 3000 series aluminum alloy sheet are prepared as set forth in Example 1. The composite structures are about 45 cm wide and 50 cm long. Epoxy-laden, fiberglass prepregs about 40 cm wide, 48 cm long are provided. A book is formed by stacking prepregs and copper foil composites in alternation, with single foils of nominal ½-ounce copper on the distal faces of the top and bottom prepregs. The book is placed between the platens of a horizontal hot press. The entire assembly is put under about 225 psi pressure and heated to about 185° C. for about 90 minutes to soften the epoxy. The assembly is partially cooled while still under pressure, thereby bonding each foil to the contiguous prepreg face and forming a clad laminate from each prepreg. The pressure is then released and the assembly removed from the press. Subsequently the conductive foils are parted at the joints to allow the carrier layers to be removed and the clad laminates separated. After completion of the hot-pressing cycle, the bonding joining the layers of each metal foil composite structure is substantially weakened, so the parting can be done with very minimal application of force. As a result, the clad laminates are easily removed without inducing bending, warpage, or other mechanical defects. A single clad laminate may be etched to define the traces of a double-sided circuit board, or plural laminates may be etched and further laminated together to form a multi-layer circuit board.

Having thus described the invention in rather full detail, it will be understood that such detail need not be strictly adhered to but that various changes and modifications may suggest themselves to one skilled in the art, all falling within the scope of the invention as defined by the subjoined claims.

What is claimed is:

1. A metal foil composite structure, comprising:
a) first and second conductive metal foil layers having substantially the same width, each layer having opposite lateral edges;
b) a carrier layer having a width less than the width of said first and second conductive metal layers and being disposed therebetween, forming a margin at each of said lateral edges; and
c) said first and second conductive layers being joined to each other only within said margins.

2. A metal foil composite structure as recited by claim 1, wherein said first and second conductive metal layers are composed of copper.

3. A metal foil composite structure as recited by claim 1, wherein each of said first and second conductive metal layers has a thickness ranging from about 5 to 400 μm.

4. A metal foil composite structure as recited by claim 3, wherein each of said first and second conductive metal layers has a thickness ranging from about 8 to 70 μm.

5. A metal foil composite structure as recited by claim 1, wherein said first and second conductive metal layers have a width ranging from about 30 to 150 cm.

6. A metal foil composite structure as recited by claim 1, wherein said carrier layer is composed of at least one of copper, aluminum, nickel, steel, and stainless steel sheets.

7. A metal foil composite structure as recited by claim 1, wherein said carrier layer is coated or plated with an agent imparting at, least one of corrosion resistance, abrasion resistance, and surface hardening.

8. A metal foil composite structure as recited by claim 1, wherein said carrier layer is composed of aluminum.

9. A metal foil composite structure as recited by claim 1, wherein said carrier layer has a thickness ranging from about 25 μm to 1.5 mm

10. A metal foil composite structure as recited by claim 1, wherein said margins have widths ranging from about 3 to about 25 mm.

11. A metal foil composite structure as recited by claim 1, wherein said joining comprises mechanical interlocking.

12. A metal foil composite structure as recited by claim 11, wherein said mechanical interlocking is accomplished by a process comprising punching.

13. A metal foil composite structure as recited by claim 1, wherein said joining comprises use of an adhesive agent.

14. A metal foil composite structure as recited by claim 1, wherein said joining comprises welding.

15. A metal foil composite structure as recited by claim 1, wherein said carrier is composed of a polymer.

16. A process for producing a metal foil composite structure, comprising the steps of:
a) providing first and second conductive metal layers having substantially the same width, each conductive metal layer having opposite lateral edges;
b) providing a carrier layer having a width less than the width of said first and second conductive metal layers;
c) interposing said carrier layer between said first and second conductive metal layers to form a margin at each of said lateral edges; and
d) joining said first and second conductive layers to each other only within said margins.

17. A process for producing a metal foil composite structure as recited by claim 16, wherein said first and second conductive metal layers are composed of copper.

18. A process for producing a metal foil composite structure as recited by claim 16, wherein each of said first and second conductive metal layers has a thickness ranging from about 8 to 70 μm.

19. A process for producing a metal foil composite structure as recited by claim 16, wherein said first and second conductive metal layers have a width ranging from about 30 to 150 cm.

20. A process for producing a metal foil composite structure as recited by claim 16, wherein said carrier layer is composed of at least one of copper, aluminum, nickel, steel, and stainless steel sheet.

21. A process for producing a metal foil composite structure as recited by claim 16, wherein said carrier layer is composed of aluminum.

22. A process for producing a metal foil composite structure as recited by claim 16, wherein said carrier layer is composed of a polymer.

23. A process for producing a metal foil composite structure as recited by claim 16, wherein said margins have widths ranging from about 3 to 25 mm.

24. A process for producing a metal foil composite structure as recited by claim 16, wherein said joining comprises mechanical interlocking.

25. A process for producing a metal foil composite structure as recited by claim 24, wherein said mechanical interlocking is accomplished by a process comprising punching.

26. A process for producing a metal foil composite structure as recited by claim 24, wherein said mechanical interlocking is accomplished by a process comprising crimping.

27. A process for producing a metal foil composite structure as recited by claim 16, wherein said joining comprises use of an adhesive agent.

28. A process for producing a metal foil composite structure as recited by claim 16, wherein said joining comprises welding.

29. A process for producing a clad laminate, comprising the steps of:
a) providing a dielectric substrate having a top surface and a bottom surface;
b) providing a metal foil composite structure comprising: (i) first and second conductive metal foil layers having substantially the same width, each layer having opposite lateral edges and (ii) a carrier layer having a width less than the width of said first and second conductive metal layers and (iii) being disposed therebetween, forming a margin at each of said lateral edges; and (iii) said first and second conductive layers being joined to each other only within said margins;
c) bonding one of said conductive metal layers to one of said surfaces of said dielectric substrate;

30. A process as recited by claim 29, wherein a plurality of said metal foil composite structures and a plurality of said dielectric substrates are provided, and said process further comprises the steps of:
a) stacking said dielectric substrates with one of said metal foil composite structures interposed between adjacent dielectric substrates;
b) placing end conductive foil layers on the outermost surfaces of the first and last substrates in the stack, said substrates, said metal foil composite structures, and said end conductive foil layers collectively forming a book;
c) pressing and heating said book between the platens of a press;
d) cooling said book to effect a bond linking each of said conductive layers in said metal foil composite structures and said end conductive foil layers to the surface of the dielectric substrate proximate that foil to form a clad laminate from each of said dielectric substrates; and
e) separating said book by parting the peripheral joined edges of the foils of each of said metal foil composite structures, thereby releasing said individual clad laminates and said carrier layers of each composite structure

31. A process as recited by claim 30, wherein each of said end conductive layers and said metal foil composite structures has substantially the same configuration.

32. A process as recited by claim 31, wherein each of said end layers comprises a sacrificial layer instead of one of said conductive metal foil layers, the sacrificial layer being disposed on the outermost faces of said book.

33. An improved process for producing a clad laminate, the improvement comprising the use of at least one metal foil composite structure, comprising:
a) first and second conductive metal foil layers having substantially the same width, each layer having opposite lateral edges;
b) a carrier layer having a width less than the width of said first and second conductive metal layers and being disposed therebetween, forming a margin at each of said lateral edges; and
c) said first and second conductive layers being joined to each other only within said margins.
